(19) United States
(12) Patent Application Publication
(10) Pub. No.: US 2025/0302686 A1
(43) Pub. Date: Oct. 2, 2025

(54) Memorial Structure For Cremated Beings

(71) Applicant: Gabriel Lobaton, Laguna Hills, CA (US)

(72) Inventor: Gabriel Lobaton, Laguna Hills, CA (US)

(21) Appl. No.: 18/620,767

(22) Filed: Mar. 28, 2024

(51) Int. Cl. A61G 17/08

(52) U.S. Cl. CPC A61G 17/08

(57) ABSTRACT

A memorial structure for cremated beings generally comprising a body portion, an exterior portion, a storage cavity, and a lid. The exterior portion is designed to depict a three-dimensional re-creation of a section of a body of a cremated being. The storage cavity is positioned in the body portion and designed to receive and store ashes of a cremated being, the storage cavity includes an orifice positioned in the exterior portion. The lid is positioned to cover and close the orifice and form part of the exterior portion. Alternatively, the memorial structure is solid throughout and the ashes of the cremated being are mixed or otherwise dispersed in the material that makes up the memorial structure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to memorial structures and more particularly pertains to a new memorial structure for cremated beings for displaying an image of the cremated being, such as a human or animal that was cremated, that also houses the ashes of the cremated being.

### (2) Description of Related Art Including Information Disclosed Under 37 CFR 1.97 and 1.98

The prior art relates to memorial structures. The prior art, as best understood, does not disclose a memorial structure for cremated beings, which structure displays an image of the cremated being, such as a human or animal that was cremated, and also houses the ashes of the cremated being in a cavity that is accessible through an opening in the outer surface of structure, or that has the ashes mixed or dispersed in the material that makes up the memorial structure.

### BRIEF SUMMARY OF THE INVENTION

An embodiment of the disclosure meets the needs presented above in a memorial structure for cremated beings generally comprising a body portion, an exterior portion, a storage cavity, and a lid. The exterior portion is designed to depict a three-dimensional re-creation of a section of a body of a cremated being. The storage cavity is positioned in the body portion and designed to receive and store ashes of a cremated being, the storage cavity includes an orifice positioned in the exterior portion. The lid is positioned to cover and close the orifice and form part of the exterior portion, the lid is removable to permit insertion of ashes of a cremated being into the storage cavity. In an alternative embodiment, the memorial structure does not have a cavity, but rather is solid throughout and the ashes of the cremated being are mixed or otherwise dispersed in the material that makes up the memorial structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a memorial structure for cremated beings according to an embodiment of the disclosure.

FIG. 2 is a front view of an embodiment of the disclosure.

FIG. 3 is a top view of an embodiment of the disclosure.

FIG. 4 is a cross-sectional view of an embodiment of the disclosure.

FIG. 5 is a side view of another embodiment of the disclosure.

FIG. 6 is a cross-sectional view of the embodiment of the disclosure in FIG. 5.

### DETAILED DESCRIPTION OF THE INVENTION

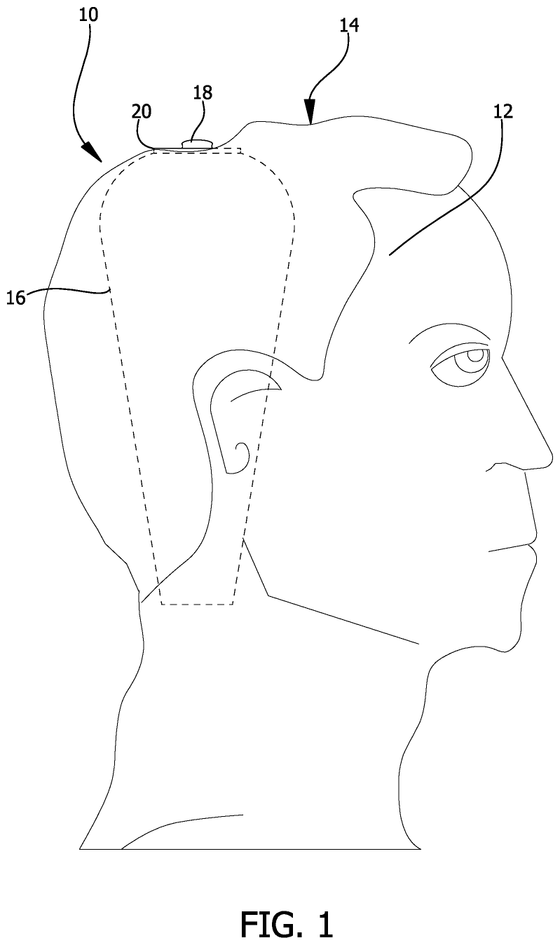

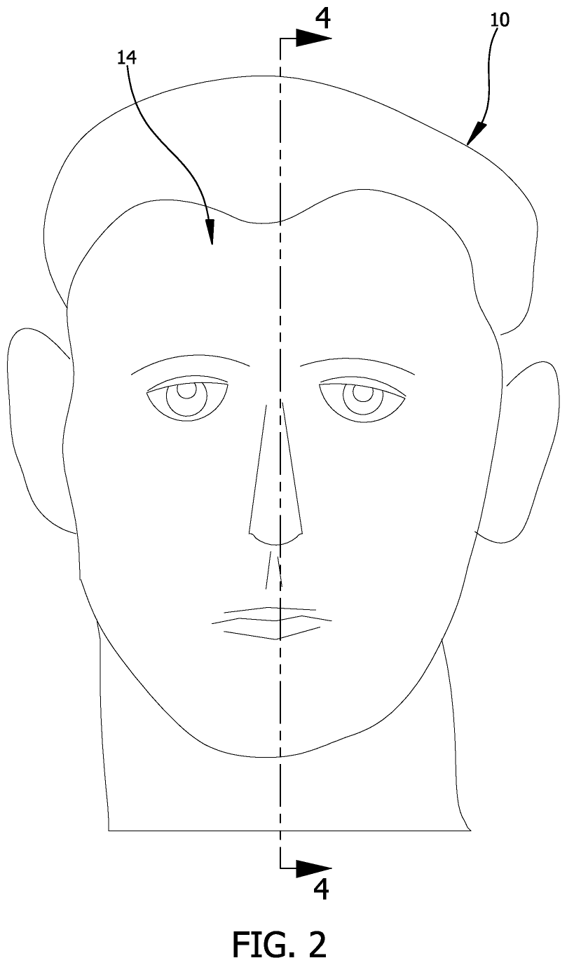

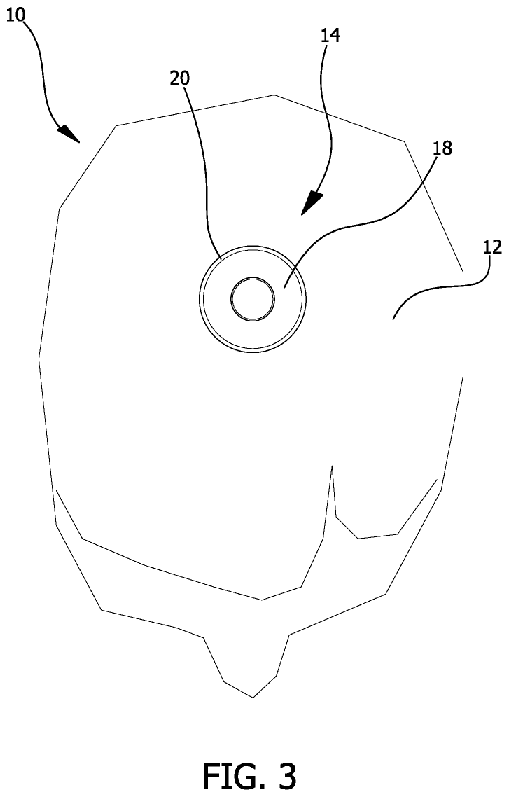

With reference now to the drawings, and in particular to FIGS. 1 through 6 thereof, a new memorial structure for cremated beings embodying the principles and concepts of an embodiment of the disclosure and generally designated by the reference numeral 10 will be described.

As best illustrated in FIGS. 1 through 4, the memorial structure 10 generally comprises body portion 12, an exterior portion 14, a storage cavity 16, and a lid 18.

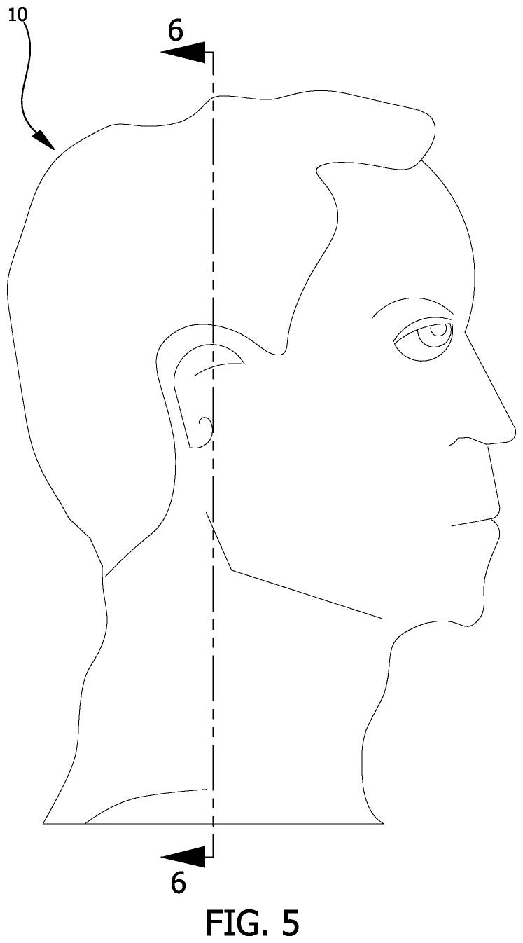

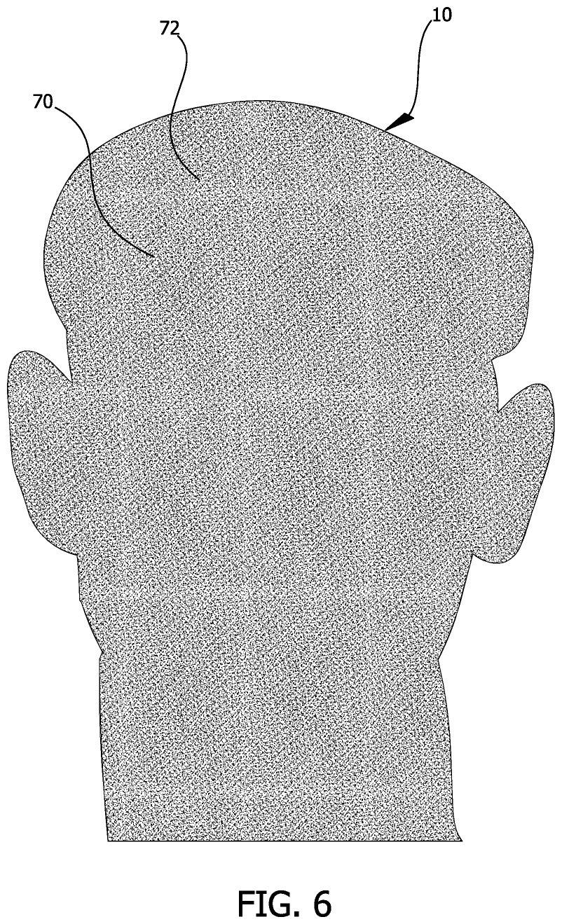

FIGS. 5 and 6 show an alternative embodiment of the memorial structure 10, wherein the storage cavity 16 and lid 18 are omitted, as will be discussed further below. The body portion 12 is made of a durable material, such as wood, metal, stone, plastic, ceramic, or cement. It could be made by sculpting material, forming in a mold, or by 3-D printing. The exterior portion 14 is designed to depict a three-dimensional re-creation of a section of a body of a cremated being, which could be a human or an animal. The exterior portion 14 depicts one of: the facial area of the cremated being, the head of the cremated being, the head, neck, and shoulders of the cremated being, and the entire body of a cremated being. FIGS. 1 through 6 show a human head, such as a bust, but essentially any depiction of all or part of a cremated human or animal is within the scope of the disclosure. In this manner, the loved ones of the deceased and cremated person or animal can look at an image of the person or animal rather than simply a box-shaped or vase-shaped urn.

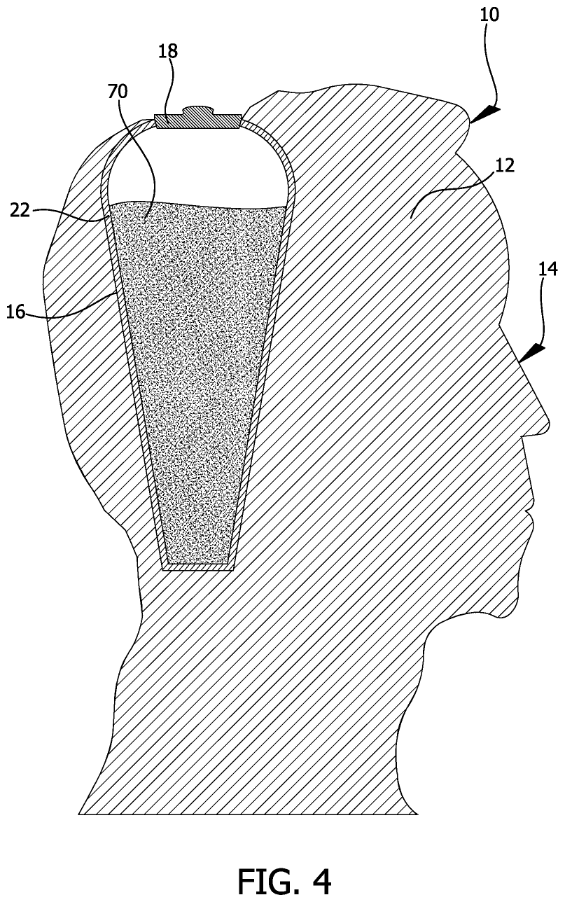

The storage cavity 16 is positioned in the body portion 12 and designed to receive and store ashes 70 of a cremated being. The storage cavity 16 includes an orifice 20 positioned in the exterior portion 14. As shown in FIGS. 1 and 4, the storage cavity 16 can be oriented vertically in an upright position with the orifice 20 positioned in a top portion of the body portion 12. The lid 18 is positioned to cover and close the orifice 20 and form part of the exterior portion 14. The lid 18 is removable to permit insertion of ashes 70 of a cremated being into the storage cavity 16. The lid 18 is designed to sealingly engage with the perimeter edge of the orifice 20. The lid 18 could be of a known design for urns and similar containers, such as a screw-on lid 18 or a friction-fit lid 18. FIG. 4 shows a possible embodiment where a lining layer 22 covers the interior surfaces of the cavity, which lining layer 22 could be made of a different material than the body portion 12. However, the cavity 16 could just be formed as an opening in the material of the body portion 12.

As mentioned above, FIGS. 5 and 6 show an alternative embodiment in which the cavity 16 has been omitted. In this embodiment, the body portion 12 is made of a formable and hardenable material 72 and the ashes 70 of the cremated being are dispersed throughout the material 72, such as by mixing the ashes 70 into the material 72 while it is in a liquefied state or working the ashes 70 into a malleable material. Such material 72 could be plastic, ceramic, cement, or similar hardenable material. In order to make this embodiment of the memorial structure for cremated beings, a manufacturer disperses the ashes 70 of the cremated being into a formable material 72, which is then formed such that the exterior portion 14 depicts a three-dimensional re-creation of a section of a body of the cremated being. The material is then hardened into the memorial structure, such as by drying or firing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A memorial structure for cremated beings comprising:
a body portion;
an exterior portion being configured to depict a three-dimensional re-creation of a section of a body of a cremated being;
a storage cavity being disposed in said body portion and configured to receive and store ashes of a cremated being, said storage cavity comprising an orifice disposed in a top of said exterior portion such that the storage cavity extends downwardly into the body portion and is configured to contain the ashes of the cremated being within the storage cavity, the storage cavity having an outer circumference flaring from a bottom of the storage cavity towards a top of the storage cavity; and
a lid being disposed to cover and close said orifice and form part of said exterior portion, said lid being removable to permit insertion of ashes of a cremated being into said storage cavity.

2. The memorial structure for cremated beings of claim 1, wherein said lid is configured to sealingly engage with the perimeter edge of said orifice.

3. The memorial structure for cremated beings of claim 1, wherein said storage cavity is oriented vertically in an upright position with said orifice disposed in a top portion of said body portion.

4. The memorial structure for cremated beings of claim 1, wherein said lid comprises a screw-on lid.

5. The memorial structure for cremated beings of claim 1, wherein said lid comprises a friction-fit lid.

6. The memorial structure for cremated beings of claim 1, wherein said memorial structure comprises a lining layer covering the interior surfaces of said cavity.

7. The memorial structure for cremated beings of claim 6, wherein and said lining layer comprises a different material than said body portion.

8. The memorial structure for cremated beings of claim 1, wherein said body portion comprises a durable material comprising wood, metal, stone, plastic, ceramic, or cement.

9. The memorial structure for cremated beings of claim 1, wherein the cremated being was a human or an animal.

10. The memorial structure for cremated beings of claim 9, wherein said exterior portion depicts the facial area of the cremated being.

11. The memorial structure for cremated beings of claim 9, wherein the exterior portion depicts the head of the cremated being.

12. The memorial structure for cremated beings of claim 9, wherein the exterior portion depicts the head, neck, and shoulders of the cremated being.

13. The memorial structure for cremated beings of claim 9, wherein the exterior portion depicts the entire body of a cremated being.

14. (canceled)

15. (canceled)

16. (canceled)

17. (canceled)

18. (canceled)

19. (canceled)

20. (canceled)
